(19) United States
(12) Patent Application Publication
(10) Pub. No.: US 2011/0107673 A1
(43) Pub. Date: May 12, 2011

(54) MOVABLE BARRIER FOR CONTROLLING ACCESSES IN GENERAL

(75) Inventor: Giovanni Ippolito, Milano (IT)

(73) Assignee: TERREX S.A., Tegna (CH)

(21) Appl. No.: 13/002,722

(22) PCT Filed: Jul. 6, 2009
(86) PCT No.: PCT/EP09/58531

§ 371 Date: Jan. 5, 2011

(30) Foreign Application Priority Data
Jul. 7, 2008 (IT) MI2008A001236

(51) Int. Cl. E06B 3/50; E05D 15/48

(52) U.S. Cl. 49/150; 49/152

(57) ABSTRACT

A movable barrier for controlling accesses in general, comprising at least one wing which is provided by at least two mutually connected panels which can rotate to arrange themselves in a mutually superimposed position and in a side-by-side adjacent position as a continuation of each other, in the access blocking position the two panels being in a mutually superimposed position.

### TECHNICAL FIELD

The present invention relates to a movable barrier for controlling accesses in general.

### BACKGROUND ART

As is known, movable barriers are typically provided for physical access control and, in a usual embodiment, have a passage, generally having an elongated shape, which is controlled by two separate doors that open selectively, in that in order to open one door the other door must be in the closed position, so that in normal conditions direct passage is not possible.

In these embodiments, typically the doors are provided by mutually opposite wings which can slide, and therefore it is necessary to have available lateral spaces in order to allow the movement of the wings.

Another problem further consist in that the use of a sliding wing that lies practically on a single plane provides a protection that, in some cases, may not allow adequate resistance to breaking through.

### DISCLOSURE OF THE INVENTION

The aim of the invention is to eliminate the drawbacks noted above, by providing a movable barrier for controlling accesses in general that allows to control a passage without requiring additional spaces for the movement of the openable elements.

Within this aim, an object of the invention is to provide a movable barrier that allows to perform, if required, controls that can be constituted by automatic comparisons with secure electronic elements and/or with biometric comparisons, with the possibility to implement the barrier as a function of the degree of security that is to be obtained.

Another object of the present invention is to provide a movable barrier that allows, if necessary, to provide rapid exit, preventing the occurrence of panic conditions or otherwise dangerous conditions due to the crowding that can occur.

Still another object of the present invention is to provide a movable harrier which, thanks to its particular constructive characteristics, is capable of giving the greatest assurances of reliability and safety in use.

This aim, and these and other objects that will become better apparent hereinafter are achieved by a movable barrier for controlling accesses in general, comprising at least one wing which is provided by at least two mutually connected panels which can rotate to arrange themselves in a mutually superimposed position and in a side-by-side adjacent position as a continuation of each other, characterized in that said at least one wing, in the access blocking position, has said at least two panels in a mutually superimposed position.

### BRIEF DESCRIPTION OF THE DRAWINGS

Further characteristics and advantages will become better apparent from the description of a preferred but not exclusive embodiment of a movable barrier for controlling accesses in general, illustrated by way of non-limiting example in the accompanying drawings, wherein:

FIG. 1 is a schematic perspective view of the movable barrier according to the invention;

FIG. 2 is a schematic plan view of the movable barrier preset for the entry of a person;

FIG. 3 is a view of the entry step, with provision of a delimited space;

FIG. 4 is a view of the opening of the space to allow authorized access;

FIG. 5 is a view of a different embodiment of the individual wings shown in the closed position;

FIG. 6 is a view of the opening step, with the possibility of passage for a single person;

FIG. 7 is a view of the movable barrier returned to the closed position after the passage of a person;

FIG. 8 is a view of the movable barrier arranged in free access conditions;

FIG. 9 is a view of further wing actuation means.

FIGS. 10 and 11 are a view of a different embodiment respectively before and after the transit of a person.

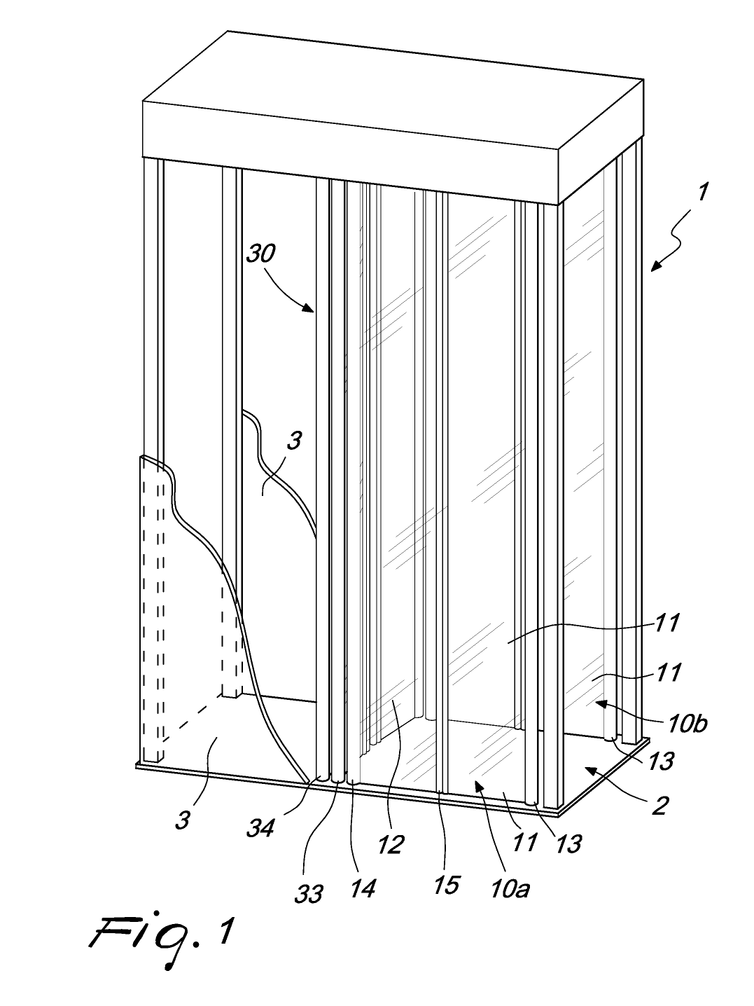

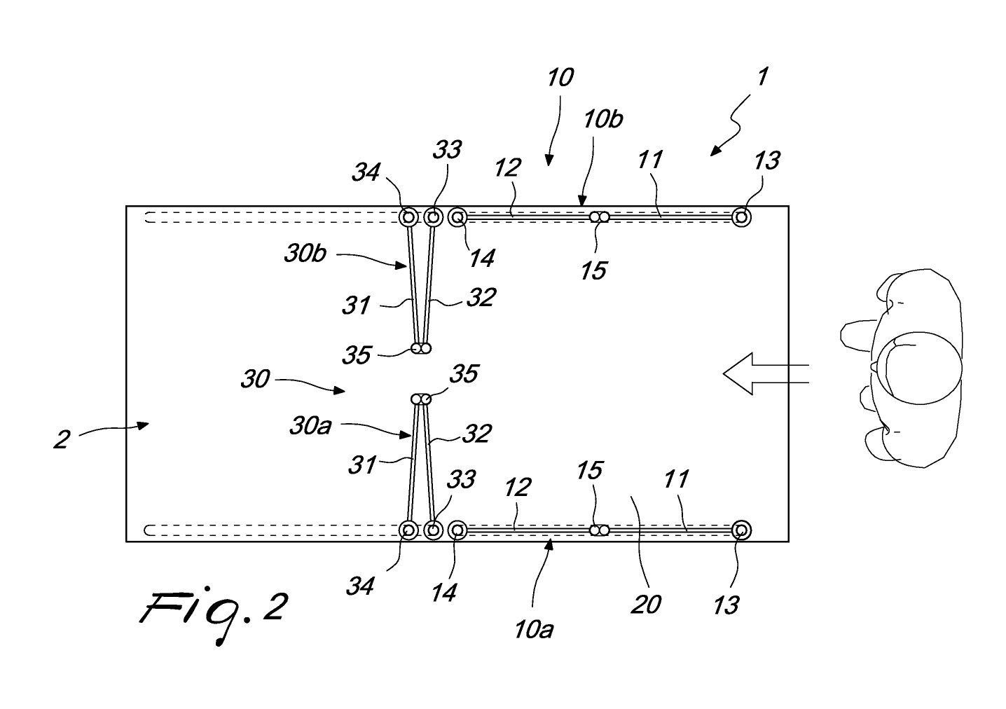

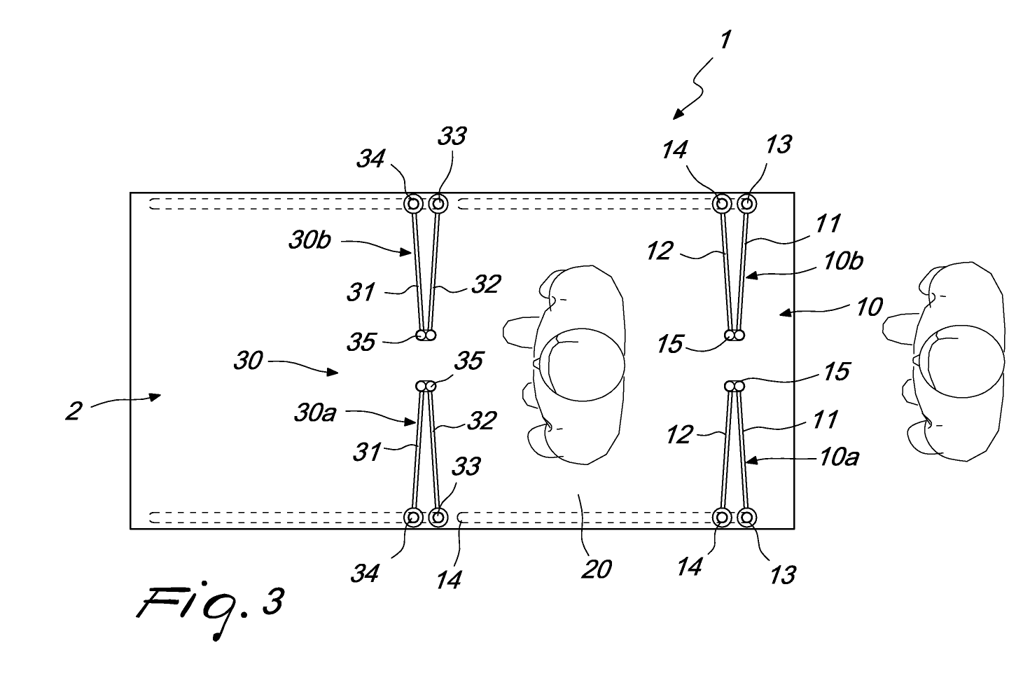

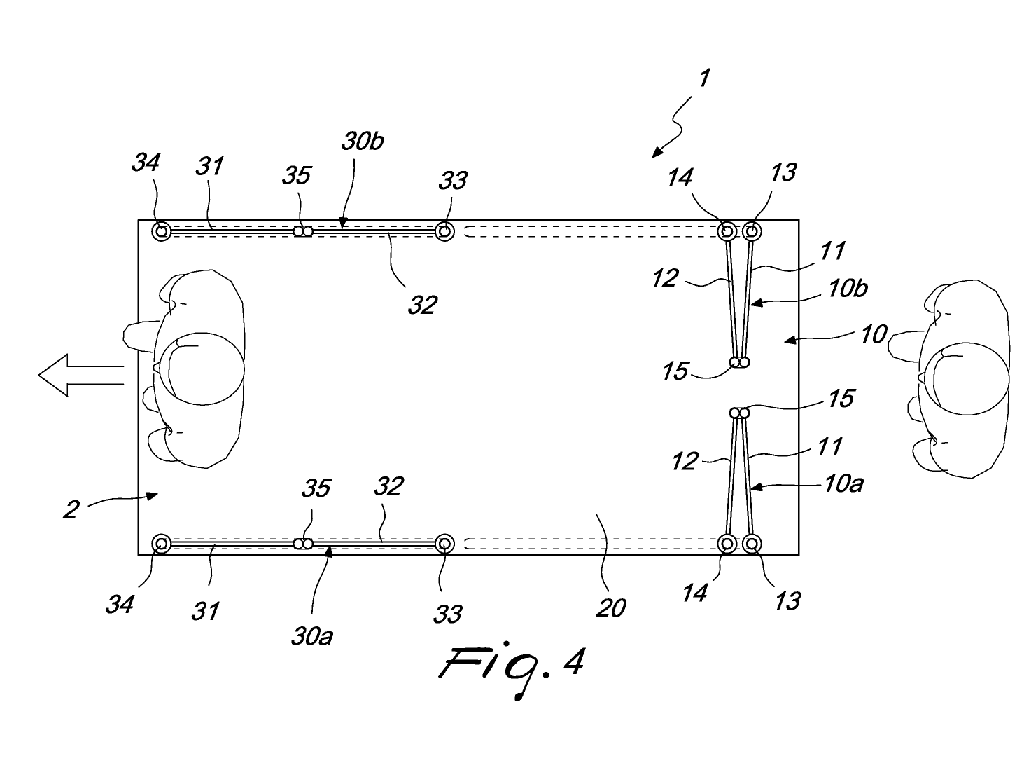

### WAYS OF CARRYING OUT THE INVENTION

With reference to the figures, the movable barrier for controlling accesses in general, according to the invention, comprises substantially a supporting frame, generally designated by the reference numeral 1, which can be provided with any structure, both mechanical and in masonry.

The frame 1 in practice defines a passage, generally designated by the reference numeral 2, which allows entry, for example into a protected environment, for which it is necessary to use control elements in order to allow the passage of entering people; the passage 2 is delimited by side walls 3 provided in any manner.

The movable harrier comprises a first door, generally designated by the reference numeral 10, which is provided by means of a first wing 10a and a second wing 10b, each of which is provided by means of a first panel 11 and a second panel 12, which are mutually connected and can rotate in order to arrange themselves in a mutually superimposed position and in a side-by-side adjacent position as a continuation of each other, providing in practice a concertina wing that has a fixed hinge point 13 at one end and a sliding hinge point 14 at the other end, while a central hinge 15 is provided which can move within the passage 2.

An important feature of the invention is constituted by the fact that the first and second wings, when they are in the position that blocks access, have the panels that constitute them mutually superimposed, differently from what occurs, therefore, typically with concertina doors, where the barrier or closure condition is provided when the panels that constitute the concertina wing are arranged mutually side by side as a continuation of each other.

With this arrangement, a barrier is provided which in practice is obtained by two superimposed wings, which have a considerable increase in breaking-through resistance and further do not create lateral dead spaces for providing the opening and closure of the door.

In order to provide the classic safety passage that forms a closed space 20 delimited by the doors that open selectively, advantageously there is also a second door 30, which is also provided by means of a first wing 30a and a second wing 30b, each of which is constituted by a first panel 31 and a second panel 32, which have fixed hinge 33 at one end of the wing and a sliding hinge 34 at the other end. The panels 31 and 32 are joined by an intermediate hinge 35, in a manner that is fully similar to what is described for the first door 10.

The first door 10 and the second door 30 open selectively so as to allow the passage of a single person at a time and in such a manner as to always have one and only one door open, with the possibility to open both doors if danger or emergency conditions occur, so that it is possible to allow the rapid exit of people if the need arises.

For the movement of the individual wings, it is possible to provide translational motion means such as pistons and the like, which act on the movable hinges 14 or 34, or optionally rotation elements, such as motors and the like, that act on the fixed hinges 13 and 33, or optionally by way of means that act on the intermediate hinge.

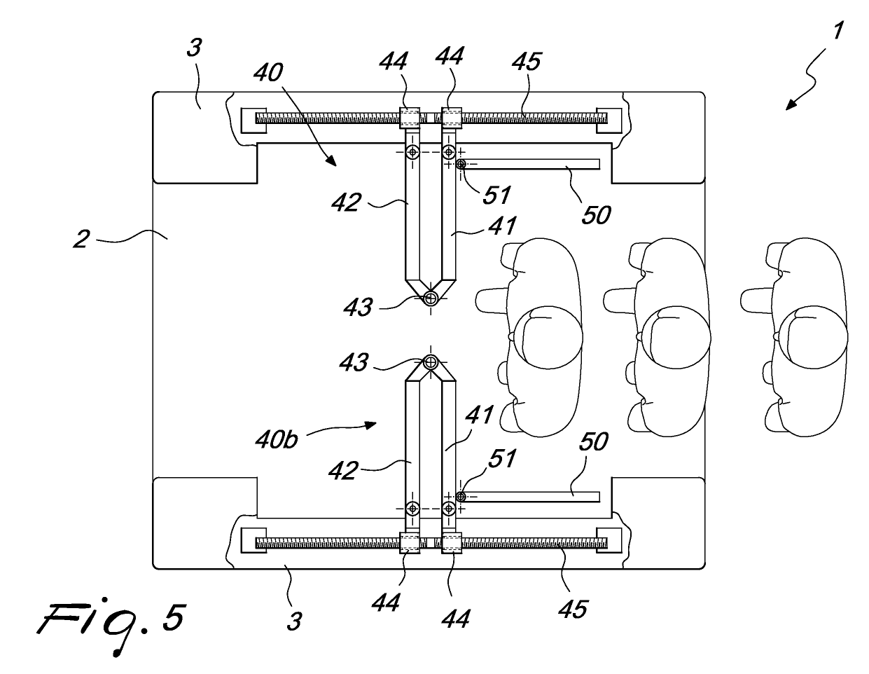

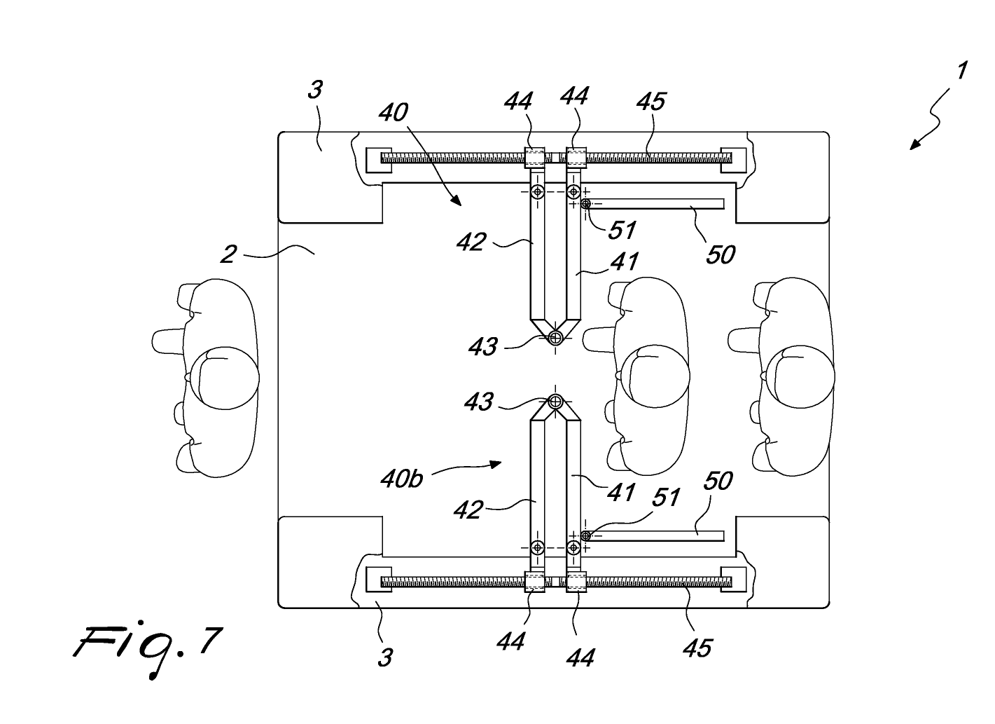

According to what is shown in FIGS. 5 to 8, it is possible to provide a door, generally designated by the reference numeral 40, which is constituted by a first wing 40a and a second wing 40b, which are provided by means of a first panel 41 and a second panel 42, which are mutually hinged at the respective central edge 43 and have, at the other end, i.e., at the outer edges, coupling joints provided by means of sleeves 44 that are threaded internally and engage a bar 45 with mutually opposite threads, which is turned so that the sleeves can slide mutually toward each other to close and away from each other to open the corresponding door.

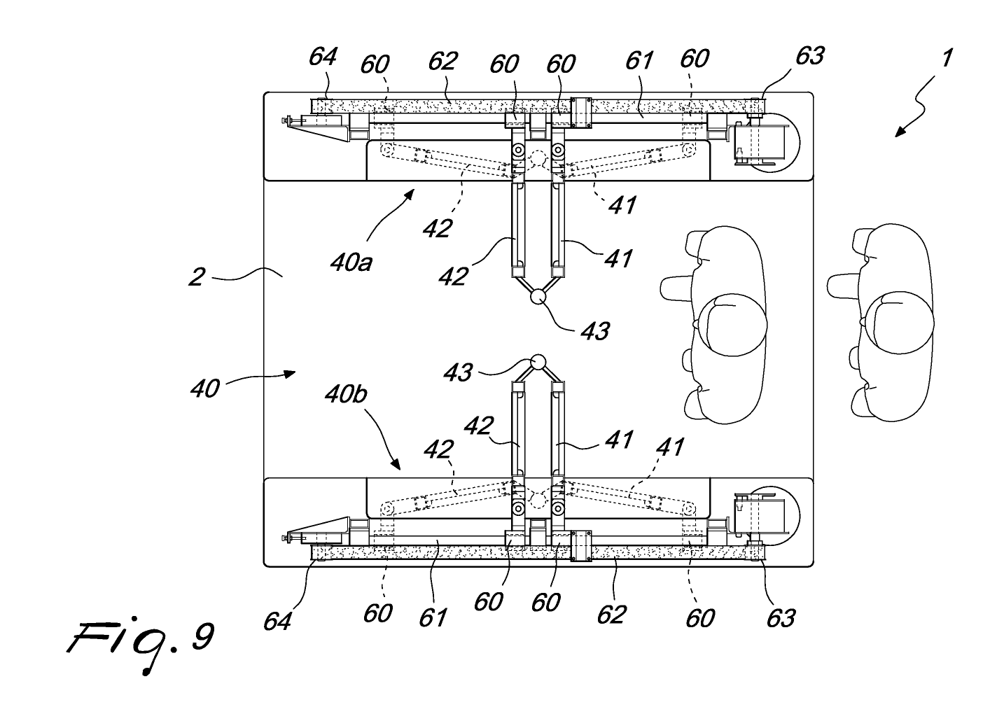

According to what is shown in FIG. 9, in order to move the wings 40a and 40b it is possible to provide smooth sleeves 60, which can slide on guiding bars 61 and are connected respectively to the panels 41 and 42 that constitute each wing.

The translational motion of the sleeves occurs by means of a belt 62, which winds around a driving pulley 63 and around an idle pulley 64 and engages the sleeve of one panel with its upper portion and the sleeve of the other panel with its lower portion.

Obviously, the type of means for moving the individual wings can be changed with other practical solutions, which in any case fall within the scope of the general idea that is developed into the movement performed by the door.

The use of a central part of the wing that moves substantially only transversely allows to speed up the movements with respect to the preceding solution.

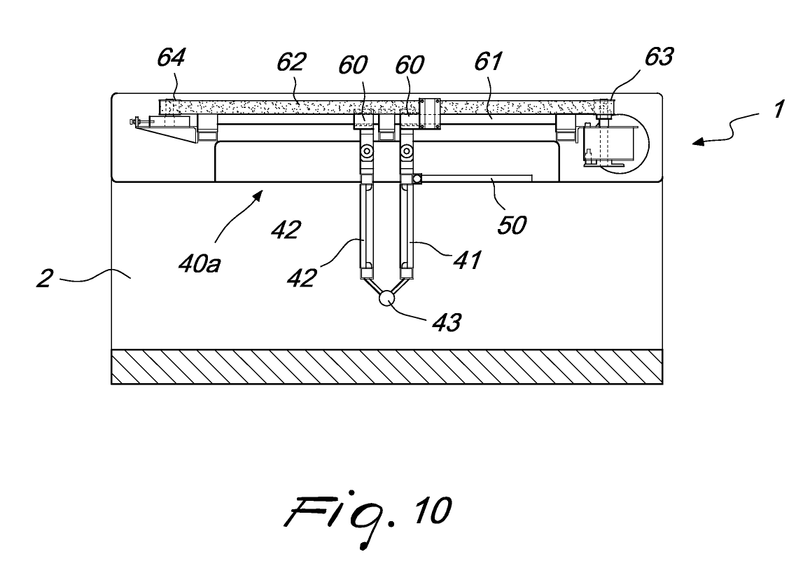

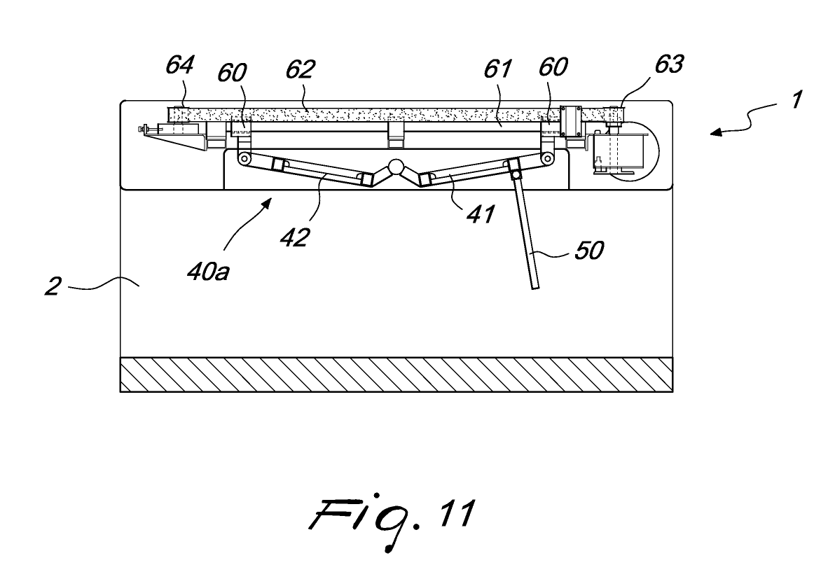

FIGS. 10 and 11 illustrate an embodiment wherein a single wing is used, arranged at one side, while, at the other side, a wall or the back of another access is provided.

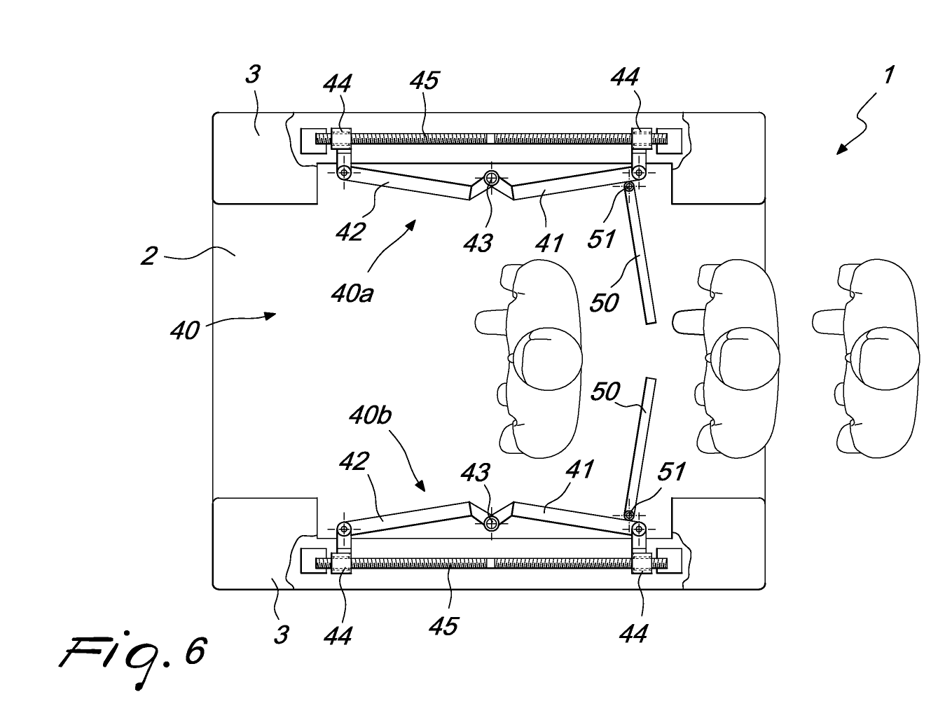

Moreover, at least one panel it is possible to provide a blocking panel 50, which is hinged to the respective panel proximate to the corresponding outer edge and can rotate about a blocking hinge 51, which is associated with the connecting panel and is substantially parallel to the central edge. The hinge 51 allows to arrange the blocking panel substantially at right angles to the panel to which it is connected, so as to provide in practice the reclosure of the passage after the transit of a single involved user, as shown schematically in FIG. 6; in this solution it is possible to confine the space for the passage of a single user by using a single door.

With the panel 50 at right angles to the corresponding connecting panel, the panel 50 arranges itself laterally to the passage in the closure position and arranges itself gradually in the blocking position when the corresponding wing is opened.

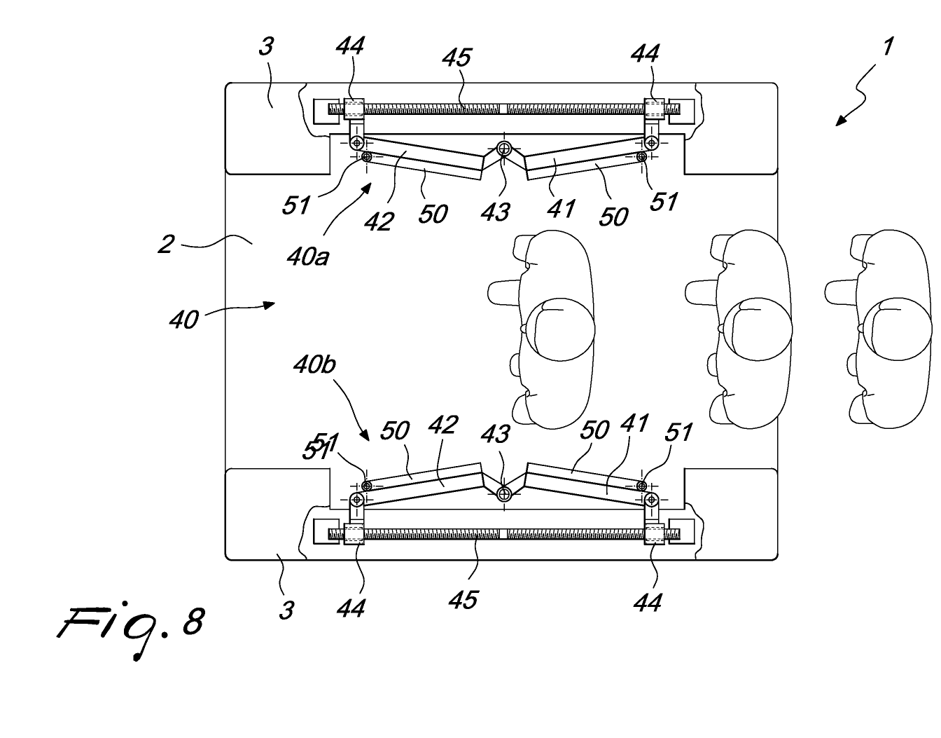

The possibility of rotation of the blocking panel allows to arrange the blocking panel so that it is superimposed on the corresponding panel in all those cases in which one wishes or needs to allow free access, as shown in FIG. 8.

It should be specified, as indicated in FIG. 8, that in the case of bidirectional transit it is possible to provide the blocking panel on both wings.

With the described solution, therefore, by using extremely reduced spaces, which correspond to the space needed for access, without therefore requiring the availability of lateral dead spaces, as typically provided in the solutions of the background art, it is possible to have a barrier which, when it is in the closed position, has a pair of elements that are mutually superimposed and spaced, thus providing considerable safety against breaking through.

The invention thus conceived is susceptible of numerous modifications and variations, all of which are within the scope of the appended claims.

All the details may further be replaced with other technically equivalent elements; it should also be specified that the illustrated variations may be used equally in all of the embodiments described previously.

In practice, the materials used, so long as they are compatible with the specific use, as well as the contingent shapes and dimensions, may be any according to requirements.

The disclosures in Italian Patent Application No. MI2008A001236 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-14. (canceled)

15. A movable barrier for controlling accesses in general, comprising at least one wing which is provided by at least two mutually connected panels which can rotate to arrange themselves in a mutually superimposed position and in a side-by-side adjacent position as a continuation of each other, wherein said at least one wing, in the access blocking position, has said at least two panels in a mutually superimposed position.

16. The movable barrier according to claim 15, further comprising a first wing and a second wing, each provided by a first panel and a second panel, said panels, in the access blocking position, being in a mutually superimposed position for each of said wings, with said wings arranged mutually side-by-side.

17. The movable barrier according to claim 15, wherein each of said wings has a first panel and a second panel, which are mutually connected, each wing having a pivoting point which is fixed at one end and a pivoting point which can slide at the other end, with a central pivoting for the connection of said panels that provide each of said wings.

18. The movable barrier according to claim 15, further comprising, for the movement of said wings, translational motion means that act on said sliding pivoting point constituted by movable hinges.

19. The movable barrier according to claim 15, further comprising, for the movement of said wings, rotation elements which act on said fixed pivoting point constituted by fixed hinges.

20. The movable barrier according to claim 16, wherein, in each of said wings, said first and second panels are mutually hinged at a central edge and the opposite outer edges can mutually slide for the opening and closure of the corresponding wing.

21. The movable barrier according to claim 20, wherein said outer edges are connected, by means of a coupling joint, to a bar with mutually opposite threads for the sliding of said outer edges in mutually opposite directions.

22. The movable barrier according to claim 20, further comprising smooth sleeves which are connected to said outer edges and can slide on a guiding bar, said sleeves engaging respectively the upper portion and the lower portion of a belt that runs between a driving pulley and an idle pulley.

23. The movable barrier according to claim 15, further comprising, on at least one of said panels, a blocking panel that is arranged substantially at right angles to the corresponding panel for the closure of said access after the transit of a single authorized user.

24. The movable barrier according to claim 23, further comprising means for the hinging of said blocking panel to the corresponding panel, which are constituted by a blocking hinge that lies substantially at right angles to the mutual hinging of said first and second panels.

25. The movable barrier according to claim 23, wherein said blocking panel can be superimposed on the corresponding panel for free transit through said passage.

26. A movable barrier for controlling accesses in general, comprising a first door and a second door, which control a passage and delimit between them a space that can be closed, each of said first and second doors being constituted by at least one wing, which is provided by at least two mutually connected panels which can rotate in order to arrange themselves in a mutually superimposed position and in a side-by-side position, wherein said at least one wing, in the access blocking position, has said at least two panels in a mutually superimposed position.

27. The movable barrier according to claim 26, wherein each one of said doors is constituted by a first wing and a second wing, which are arranged on mutually opposite sides of said passage.

28. The movable barrier according to claim 26, wherein said first and second doors can be opened selectively.
